(19) United States
(12) Patent Application Publication
(10) Pub. No.: US 2018/0232125 A1
(43) Pub. Date: Aug. 16, 2018

(54) Contextual Linking of Digital Representations of Objects with Documents

(71) Applicant: Adobe Systems Incorporated, San Jose, CA (US)

(72) Inventors: Shilpi Aggarwal, Delhi (IN); Sunandini Basu, New Delhi (IN); Sourabh Goel, Noida (IN)

(73) Assignee: Adobe Systems Incorporated, San Jose, CA (US)

(21) Appl. No.: 15/430,394

(22) Filed: Feb. 10, 2017

(51) Int. Cl. G06F 3/0481; G06F 3/0482; G06F 17/24; G06F 17/21; G06T 19/00

(52) U.S. Cl. CPC G06F 3/04815; G06F 3/0482; G06F 17/243; G06T 2200/24; G06T 19/006; G06T 19/003; G06F 17/212

(57) ABSTRACT

Contextual linking of digital representations of objects with documents is described. In one or more implementations, a portion of a document is linked to a portion of a digital representation of an object. The link contains information such as portion locations/coordinates, customized views, hyperlinks, text/notes associated with the link, audio/video associated with the link, and so on. The resulting linked document enables a user to freely navigate between the linked portions through user inputs to either portion and interact with the information associated with the link.

### BACKGROUND

The advantages of an electronic form are numerous, including an ability to easily communicate the form via a network (e.g., the internet) as well as a wide range of electronic devices that may be used to interact with the electronic form, such as desktop PCs, mobile devices such as mobile phone and tablets, and so forth. However, interaction with the electronic form in some scenarios may be limited by techniques used by an electronic device to display and navigate within the form. One such scenario involves when navigation is required between different portions of the form, that may be widely separated from each other within the form. To rent a boat, for instance, a user is typically provided with an electronic insurance form, with which, the user can specify pre-existing damage to the boat. In order to fill out the electronic form, the user is confronted with numerous portions that may involve back-and-forth navigation within the form (e.g., scrolling) to complete a task. In the boat example, a user may be forced to manually scroll between a portion of the form used to describe a state of the object (e.g., damage to the boat) in text and another portion of the formed used to attach images of the object, e.g., from a digital camera. Thus, in this example limitations in a size of a display device may also limit user interaction and navigation between the portions of the form, which can be frustrating and prone to error, e.g., due to missed portions of the form.

The opposite is also true in which a large display area that is viewable by a user may complicate navigation within the form and thus an ability of the user to complete the form. For example, recently, more advanced types of digital representations are being used to describe objects such as virtual reality (VR) environments, user manipulable 3D objects, augmented reality (AR) environments, and other virtual experiences in virtual reality or augmented reality scenarios in which objects are disposed in an environment “around” the user. For example, a user may capture multiple digital images of an object that are then combined into a single virtual reality environment containing the object. However, this immersion within the environment may make it difficult for a user to locate a particular portion of a form that is of interest as well as to navigate between the different portions.

Navigation within a typical AR/VR environment, for instance, typically requires movement on the part of the user that mimics the immersion within the environment to navigate through the content or extensive manipulation of the object. Users, for instance, that wish to view portions of the digital content that are disposed “behind them” are forced to rotate their head 180 degrees or move their phone behind them to view this portion of the content. In another instance, this navigation is used to view different portions of an object. Thus, navigation within a typical AR/VR environment may eventually become tiring and frustrating to the user. Because of these difficulties, merely attaching a AR/VR object or environment to a form does not enable a user to effectively navigate to portions of interest, e.g., to navigate between a bow of a boat in an AR/VR environment associated and a text form field related to the bow.

As a result, conventional techniques used to interact with electronic forms may become frustrating, inefficient, and inaccurate due to cumbersome and unintuitive navigation required by these techniques.

### SUMMARY

Contextual linking of digital representations of objects (i.e. digital representations) with documents is described that is based, at least in part, on linking a portion of a digital representation to a portion of a document. In this way, respective linked portions of the document and the digital representation support ease of identification and navigation between the electronic files. In an implementation, a digital medium environment includes at least one computing device that is configured to link a portion of a document to a portion of a digital representation. A document may be configured in a variety of ways, such as a portable document format containing form fields, a word processing document, a spreadsheet, an email, and so on. A digital representation of an object may also be configured in a variety of ways, such as a virtual reality (VR) or augmented reality (AR) environment containing the object, a two-dimensional (2D) file (e.g., a picture or digital image), a three-dimensional (3D) file (e.g., a computer-aided design (CAD) model), and so on.

In one example, in order to link the digital representation to the document, the document is displayed in a user interface of a computing device. A user input is received by the computing device that identifies a portion of the document (i.e., document portion) to be linked. The document portion, for instance, may be identified through selection of text via a click-and-drag operation, a gesture, a spoken utterance, and so forth. When a document portion is identified, a view specific to the document portion is also identified. For instance, the view may have the document portion highlighted, have the document portion centered in a display, or otherwise differentiate the document portion from other parts of the document. Thus, many views of the document may be generated, however, a view specific to the document portion is used to form the link.

A user input is also received by the computing device identifying the digital representation portion. This user input, for instance, may involve a “click” via a cursor control device, tap gesture, or any other technique to identify a particular portion of a digital representation. The computing device may also determine the digital representation portion and/or the document portion automatically through machine learning, artificial intelligence, object mapping, and so on, e.g., to perform object recognition based on description of an object in a text portion of a document. When a digital representation portion is identified, a view specific to the digital representation portion is also identified. For instance, the view may have the digital representation portion highlighted, have the digital representation portion centered in a display, or otherwise differentiate the digital representation portion from other parts of the digital representation. Thus, many views of the digital representation may be generated, however, a view specific to the digital representation portion is used to form the link. For example, a VR boat may be manipulated in any number of ways, however, a link to a portion of the VR boat from a linked document portion will always navigate to and/or display a similar view of the VR boat portion.

The document and digital representation portions are then linked to each other by the computing device. The linking contains information that is usable by the computing device to navigate between linked portions, such as through use of portion locations/coordinates, customized views, highlighting, hyperlinks, text/notes associated with the link, audio/video associated with the link, and so on. As a result, a navigation input that is received by the computing device through user interaction with the document portion causes the computing device to activate the link to navigate to a display specific to the linked digital representation portion, and visa-versa. For example, if a user input is received by the computing device that selects a bow portion of an electronic boat insurance form, a specific bow view of a virtual reality representation of a boat that is associated with the form is displayed. As discussed above, many views of the document and the digital representation may be generated by the computing device that contain the linked portions. As long as a view contains a linked portion, selection and navigation can occur. For example, the VR representation of the boat may be manipulated in any number of ways, but as long as the bow portion is visible, it may be selected causing navigation to the linked bow portion of the boat insurance form. In this way, a user may efficiently navigate back and forth between the linked portions in an efficient and intuitive manner.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of a digital medium environment in an example implementation that is operable to link a portion of a document with a portion of a digital representation of an object.

FIG. 2 is an illustration of an example digital medium implementation illustrating the authoring module of FIG. 1 in greater detail.

FIG. 3 is an illustration of an example implementation illustrating linking a portion of a document to a portion of a digital representation of an object.

FIG. 4 is an illustration of an example implementation illustrating linking a portion of the digital representation of the object from FIG. 3 to a portion of the document from FIG. 3.

FIG. 5 is a flow diagram depicting a procedure in an example implementation to link a portion of a document with a portion of a digital representation of an object.

FIG. 6 is a flow diagram depicting a procedure in an example implementation to navigate between a document and a linked digital representation of an object.

FIG. 7 is an illustration of a system and device in an example implementation that is operable to link portions of documents with portions of digital representations of objects.

### DETAILED DESCRIPTION

Overview

Techniques and systems are described to link a portion of a document with a portion of a digital representation of an object. For example, a view specific to a portion of virtual reality representation of a boat, such as a view of a bow, may be linked by a computing device to a bow form field of an electronic boat insurance form. In one instance, the link is implemented as a hyperlink to link a portion of a document (e.g., anchor text) to a corresponding portion of a digital representation of an object, e.g., a particular view in three dimensions, coordinates of the object, highlighting of the portion, and so forth. Other portions of the document and the digital representation may be linked by the computing device as well. Continuing the above example, views associated with the stern, windows, bridge, and so on of the digital representation of the object may be linked to form fields associated with the respective form fields in the electronic insurance form. In this way, respective linked portions of the document and the digital representation support ease of identification and navigation between the electronic files. Further, the link may support efficient use of computational resources used to output the document having the link, e.g., to support efficient navigation and thus reduce consumption of computation resources as caused by convention navigation techniques.

To form the link, the document is displayed in a user interface by a computing device. The computing device then receives a selection input from a user via a user interface that identifies a portion of a document, e.g., to select a bow form field of a boat insurance form. Next, the computing device may display a digital representation and receive a selection input from the user corresponding to a portion of a digital representation to be associated with the identified portion of the document, e.g., a bow portion of the digital representation of the boat associated with the boat insurance form. Based on these selections, the computing device forms a link (hyperlink) between the portions that is usable to navigate back-and-forth between the portions as desired. The digital representation may be a pre-existing digital representation, or the computing device may create the digital representation when the document portion is selected.

The link may be configured by the computing device in a variety of ways. For example, the link may contain information such as portion locations/coordinates, customized views, hyperlinks, text/notes associated with the link, audio/video associated with the link, and so on that are usable by the computing device to navigate between corresponding portions. As a result of the link, a navigation input that is received by the computing device through user interaction with the document portion (e.g., “clicking” the link) causes the computing device to navigate to a display specific to the linked digital representation portion, and visa-versa.

For example, a user input that selects a link associated with a linked document portion causes a computing device to display an associated digital representation and navigate to the digital representation portion using the link. The computing device, for instance, may activate a hyperlink in response to a user input to cause navigation in a user interface to specified coordinates of the portion of the digital representation, e.g., the bow. Conversely, a user input that selects a link corresponding to the linked portion of the digital representation causes the computing device activate a hyperlink to navigate within the user interface to display the portion of the document, e.g., through use of a pointer.

Although described in terms of a user selection to define portions in the above example, the computing device may also determine correspondence of portions of the document or the digital representation automatically without user intervention through machine learning, artificial intelligence, object recognition, and so on. For example, the computing device may parse the text of a section to identify text referring to a “bow of the boat” and use object recognition to form a link to a corresponding portion of the digital representation of the object, e.g., the bow. In another implementation, the portions may be designated and linked automatically by the computing device and confirmed or edited via user inputs received by the computing device. Regardless of how the portions are identified and selected, the computing device links the document portion to the digital representation portion. A user may also add information describing the link such text/notes associated with the link, audio/video associated with the link, and so on.

By linking the document portion to the digital representation portion, efficient navigation between the document and the digital representation can be realized. For example, an insurance adjustor that receives a boat insurance form with a linked 3D representation of a boat may easily navigate to appropriate sections of the 3D representation of the boat by clicking on various portions of the boat insurance form. As a result, the techniques and systems described herein may overcome conventional document limitations that required manual navigation between the respective portions, which could be cumbersome and result in user frustration. Further, the techniques and system described herein may improve efficiency in computational resources through efficient navigation and display of respective portions without needless display of intervening portions. A variety of other examples are also contemplated as further described in the following sections.

An example environment is described that may employ the document linking techniques described herein. Example procedures are also described which may be performed in the example environment as well as other environments. Consequently, performance of the example procedures is not limited to the example environment and the example environment is not limited to performance of the example procedures.

Terms

The term “document” refers to any electronic file that contains text, graphics, or any combination thereof. Although a document may contain images, it is not an image, per se. Examples of documents are word processing documents, spreadsheets, emails, forms, portable document formats (PDF), documents containing form fields, and so on.

The term “digital representation of an object” or “digital representation” refers to an electronic representation of at least one object or item. Examples of digital representations are virtual reality (VR) objects configured for output in augmented or virtual reality environments, two-dimensional (2D) files (e.g., pictures, photographs, or images), three-dimensional (3D) files (e.g., 3D representations of objects derived from multiple 2D files or computer-aided design (CAD) models), and so on. The object may exist in the real world, for example a boat in a picture, or be computer generated, for example a computer model of a boat.

The term “linked document” refers to a document that has at least one portion linked to a portion of a digital representation. The digital representation may be linked to the document through an embedding, an attachment, a link to an external source, and so on. The associated portions (document portion and digital representation portion) are connected as part of the linking between the document and the digital representation. An example of a linked document may be a PDF boat insurance form containing form fields that are linked to respective portions of an attached virtual reality environment containing a boat associated with the boat insurance form. A linked document enables a user to easily navigate between linked portions of either the document or the digital representation.

The term “hyperlink” refers to an example link between a portion of a document and portion of a digital representation. The hyperlink may be activated through a user input to the document portion of the digital representation portion to navigate between the document portion and the digital representation portion. The hyperlink may contain coordinate/location information of a linked portion or other information that enables a computing device to effectively navigate a user interface to the connected portion.

The term “authoring module” refers to functionality implemented at least partially in hardware to link a digital representation to a document to create a linked document.

Example Environment

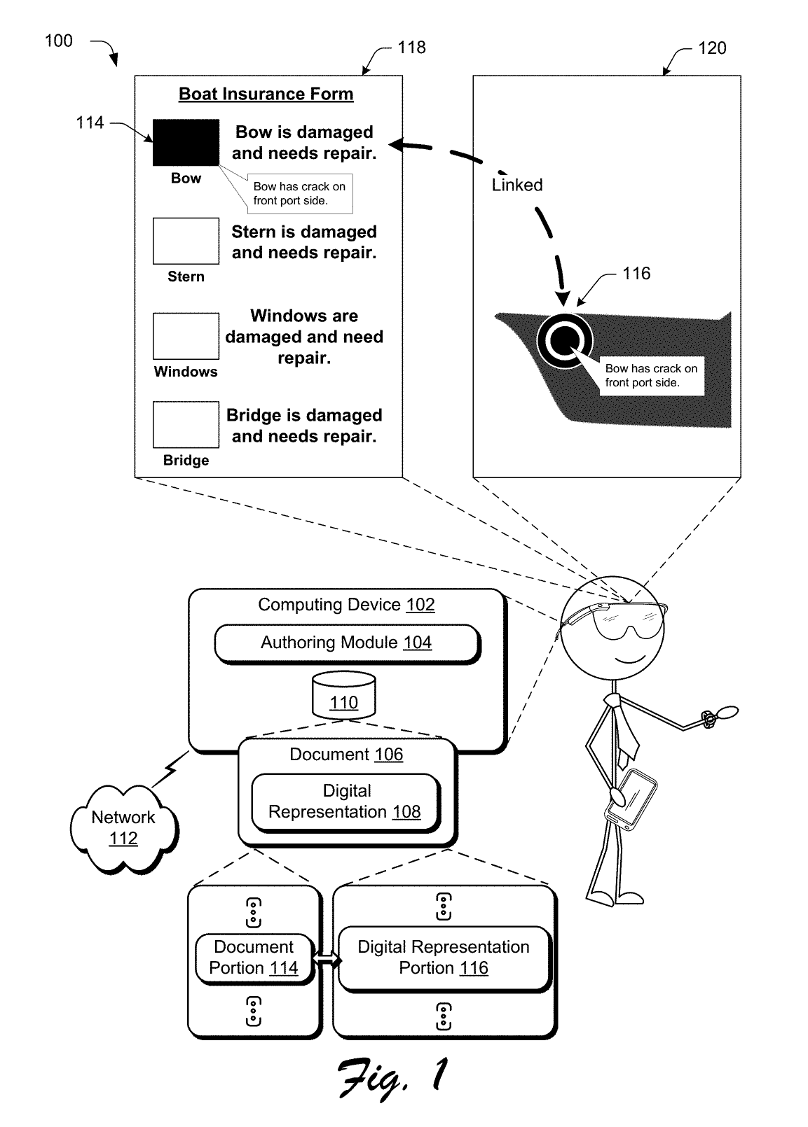

FIG. 1 depicts a digital medium environment, generally at 100, in an example implementation that is operable to enable contextual linking of digital representations of objects (i.e. digital representations) within a document. The illustrated digital medium environment 100 includes a computing device 102 such as a virtual reality headset, tablet, phone, or electronic device, that contains an authoring module 104. The authoring module 104 is implemented at least partially in hardware of the computing device 102 to create a document 106 having a digital representation 108. The authoring module 104 includes functionality to link a document portion 114 of the document 106 to a digital representation portion 116 of the digital representation 108. The digital representation 108 may be attached to the document 106, embedded within document 106, or referenced by a remote location in document 106. In one implementation, authoring module 104, document 106, digital representation 108, or any combination thereof may be implemented in whole or in part “in the cloud” via network 112, e.g., the Internet, a Wi-Fi network (e.g., in accordance with one or more IEEE 802.11 standards), a wireless network, cellular data network, and so forth.

Document 106 in this example contains at least one document portion 114 that is linked to at least one digital representation portion 116 of digital representation 108. For example, a user interface view of a document 118 may be displayed by a display device of the computing device 102 and, responsive to a user input to document portion 114, the user interface may switch to a user interface view of a digital representation 120 focused on digital representation portion 116. Conversely, user interface view of the digital representation 120 may be displayed by the display device and, responsive to a user input to digital representation portion 116, the user interface may switch to a user interface view of the document 118 focused on document portion 114. In this way, a user may efficiently navigate back and forth between displays of portions of the document and displays of portions of the digital representation.

The document 106 also supports changes that enable a user to modify either the document or the digital representation and have the linked file change. For example, if the digital representation 108 is modified the document 106 may be modified in accordance with the change. In this way, the document is responsive to changes to the digital representation and visa-versa as a result of this linking as further described below.

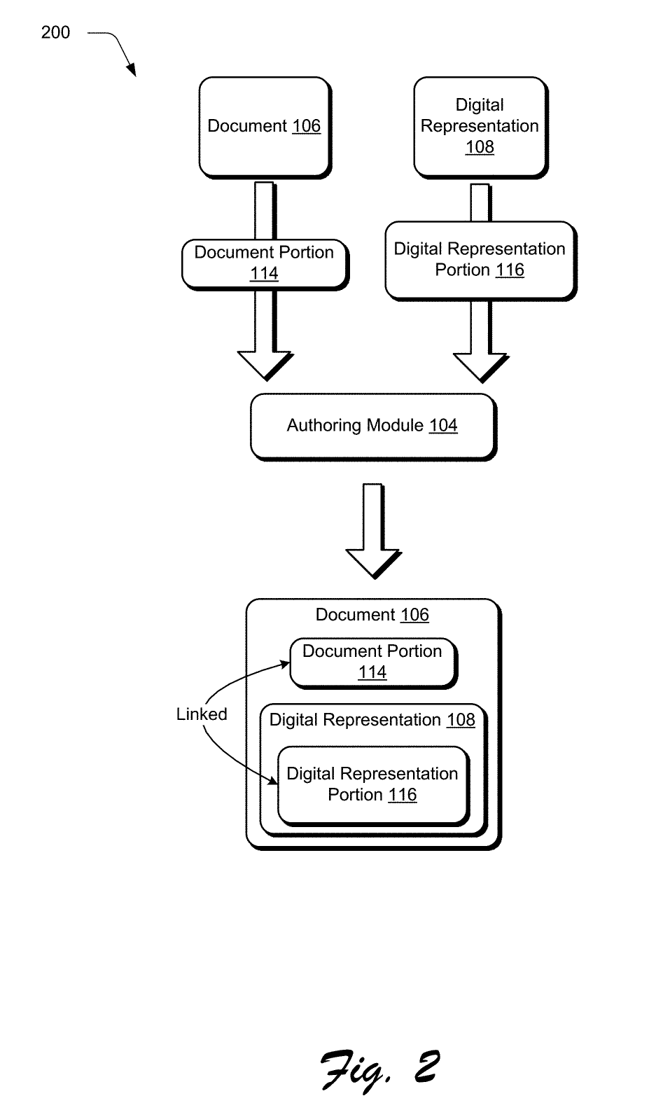

FIG. 2 depicts an example implementation, generally at 200, showing operation of the authoring module 104 of FIG. 1 in greater detail as creating the linking of document 106 and digital representation 108. To begin, the authoring module 104 receives the document 106 and the digital representation 108. If the document 106 contains a pre-existing link, then document 106 can be considered as a linked document. If the document 106 does not contain a pre-existing link, then document 106 is not considered a linked document. Although described in relation to a single object, the digital representation 108 may be configured as a digital representation of more than one object.

The document 106 and/or the digital representation 108 may be implemented local to the authoring module 104, e.g. on computing device 102, or remote to the authoring module 104, e.g. accessed over network 110. In one such example, the authoring module 104 receives the document 106 from a remote database of documents. Similarly, authoring module 104 may receive the digital representation 108 from a database of digital representations of objects including digital representation 108. For example, authoring module 104 may access a database of various repair documents for appliances as well as a database of digital representations of the appliances to link a particular repair document to an appliance.

In another example, the computing device 102 is used to create the document 106 or the digital representation 108. For example, the computing device may use a document editor such as Acrobat® to create or edit document 106. In order to create the digital representation 108, the authoring module 104 may use a local camera device as a source of data. For example, the authoring module 104 may obtain multiple images of the object and stich them together to create a virtual reality environment containing the object. The authoring module 104 may also utilize any 3D authoring tools such as Google VR SDK® or CleVR® to create the virtual reality environment containing the object.

Regardless of how the document 106 and the digital representation 108 are created and received by the authoring module 104, the authoring module 104 then detects a user input selecting the document portion 114 from the document 106. From the detected user input, the authoring module 104, identifies the document portion 114 from the rest of the document 106 through use of coordinates, user selections, feature identification, and so on. An example of the document portion 114 may be a heading, a section, a space designated for a picture, paragraph identifier, numbering, and so on.

Once the document portion 114 is identified by the authoring module 104, the user interface is navigated to the digital representation 108. As discussed above, if the digital representation 108 does not already exist at this point, the authoring module 104 may create the digital representation 108. The authoring module 104 then detects a user input in this example as selecting the digital representation portion 116 from digital representation 108. From the received digital representation portion selection, the authoring module 104 identifies the digital representation portion 116 from the rest of the digital representation 108.

The user inputs selecting the digital representation portion 116 and the document portion 114 may be received in a variety of ways. Examples of such user inputs include gestures identifying portions (i.e. circling a portion), dropped pins, specified views including pan, tilt, and zoom states, 2D or 3D coordinates, highlighting, selecting headings, mousing functions, creating shapes around portions, and so on. Portions of the document 106 and the digital representation 108 may also be identified by the authoring module 104 without receiving user inputs (such as through use of feature recognition, machine learning, artificial intelligence, and so on) or pre-defined such as the form fields of the boat insurance form discussed above. Portions may also be identified without receiving user inputs and confirmed or selected by received user inputs.

As part of the portion linking process, the authoring module 104 may receive text/notes associated with the link, audio/video associated with the link, and so on via user inputs that help describe the link and any meaningful details about the link and the respective portions. The additional information may be received as either portion is identified, when a link between portions is created, or after the linked document 106 is created.

Once both the document portion 114 and the digital representation portion 116 are identified by the system, the authoring module 104 links document 106 to digital representation 108 through linking document portion 114 to digital representation portion 116 to make document 106 a linked document. The document 106 now contains the digital representation 108, e.g., as embedded within the document 106, as an attachment to the document 106, as a remote resource locatable through an address or uniform resource locator (URL), and so on as discussed above. The linking between the document portion 114 and digital representation portion 116 is such that an input received by the computing device to either portion causes navigation within a user interface to the other respective portion in the user interface. The link between portions may be implemented as a hyperlink that contains instructions for the navigation or may contain a link to database that contains the instructions. For example, a hyperlink embedded as part of link may contain instructions to navigate to a particular virtual reality view. The instructions may contain pan, tilt, and zoom states for the digital representation and/or coordinates or other identifying information of the particular portion of the digital representation such that the particular portion will be consistently navigated to and/or identified when the document portion is selected in the linked document. The hyperlink may also highlight or somehow distinguish a linked portion in either the linked document 106 or the linked digital representation 206.

Although the above environment is described linking a single document portion, such as a single form field, to a single digital representation portion, such as a single virtual reality view, multiple portions of a document may be linked to multiple respective portions of a digital representation of an object. For example, multiple form fields of an electronic form may be linked to multiple respective virtual reality views of an object associated with the form. Furthermore, multiple digital representations may be utilized in order to link various portions of a document with multiple digital representations of an object or multiple digital representations corresponding to different objects. For example, an electronic form may contain one form field linked to a first representation of an object and another form field linked a second representation of the same object. Alternatively, the electronic form may contain one form field linked to a representation of first object and another form field linked to a representation of second object.

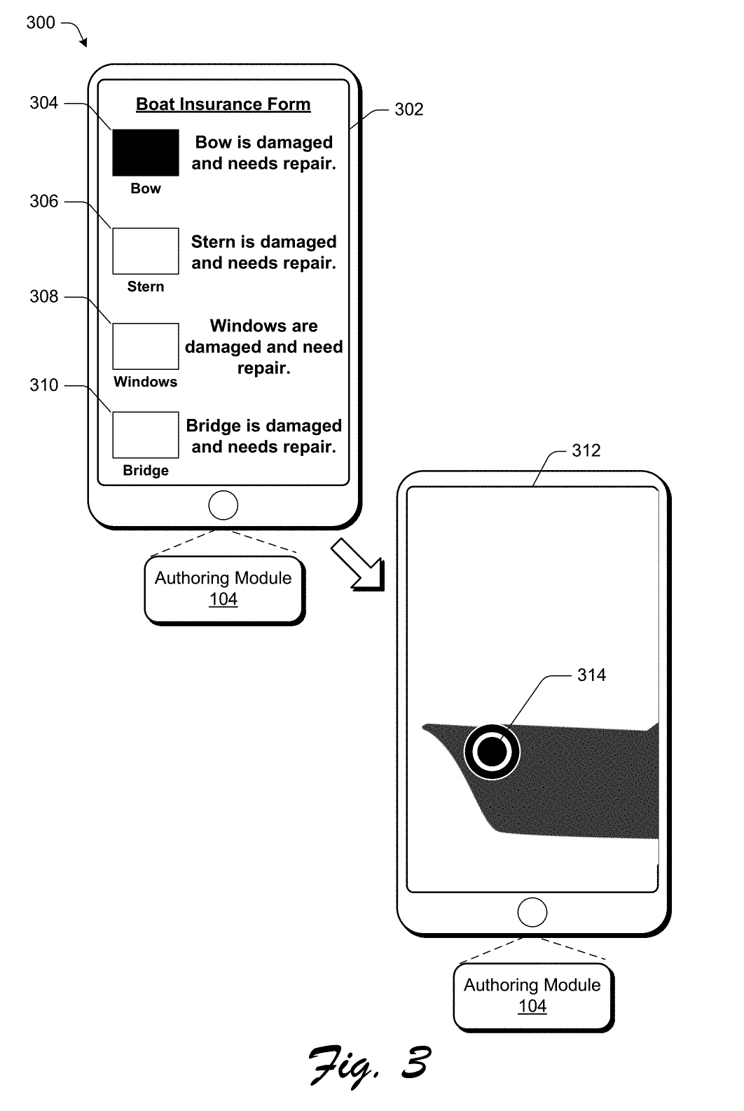

FIG. 3 depicts an example implementation, generally at 300, showing functions of the authoring module 104. In this example, a boat insurance form 302 is displayed in a user interface. The boat insurance form 302 contains various portions pertaining to a bow portion of the boat insurance form 304, a stern portion of the boat insurance form 306, a windows portion of the boat insurance form 308, and a bridge portion of the boat insurance form 310. A user input is received by the authoring module 104 selecting the bow portion of the boat insurance form 304 for linking. Once the bow portion of the boat insurance form 304 is selected, the authoring module 104 causes the user interface to switch to a digital representation of a boat 312 associated with the boat insurance form 302. A selection input is then received by the authoring module 104 identifying a portion of the digital representation of the boat 312 for linking to the bow portion of the boat insurance form 304. Again, the digital representation of the boat 312 may be created responsive to receiving the selection of the bow portion of the boat insurance form 304 or may exist prior to receiving the selection.

A user input is then received by the authoring module 104 selecting the bow portion of the digital representation of the boat 314 for linking to the bow section of the boat insurance form 304. Responsive to receiving the input selecting the bow portion of the digital representation of the boat 314, the authoring module 104 links the bow portion of the boat insurance form 304 to the bow portion of the digital representation of the boat 314. The link may contain navigation instructions such as coordinates of the respective portions, such that the computing device can distinguish the portions from the rest of the document/digital representation and navigate to the respective portions. In order to show that the portions are linked, the authoring module 104 may cause the user interface to display a visual indication indicating that the portions are linked in the document and/or the digital representation. Examples of visual indications are highlighting, a pronounced border, shading, shapes surrounding portions, and so on.

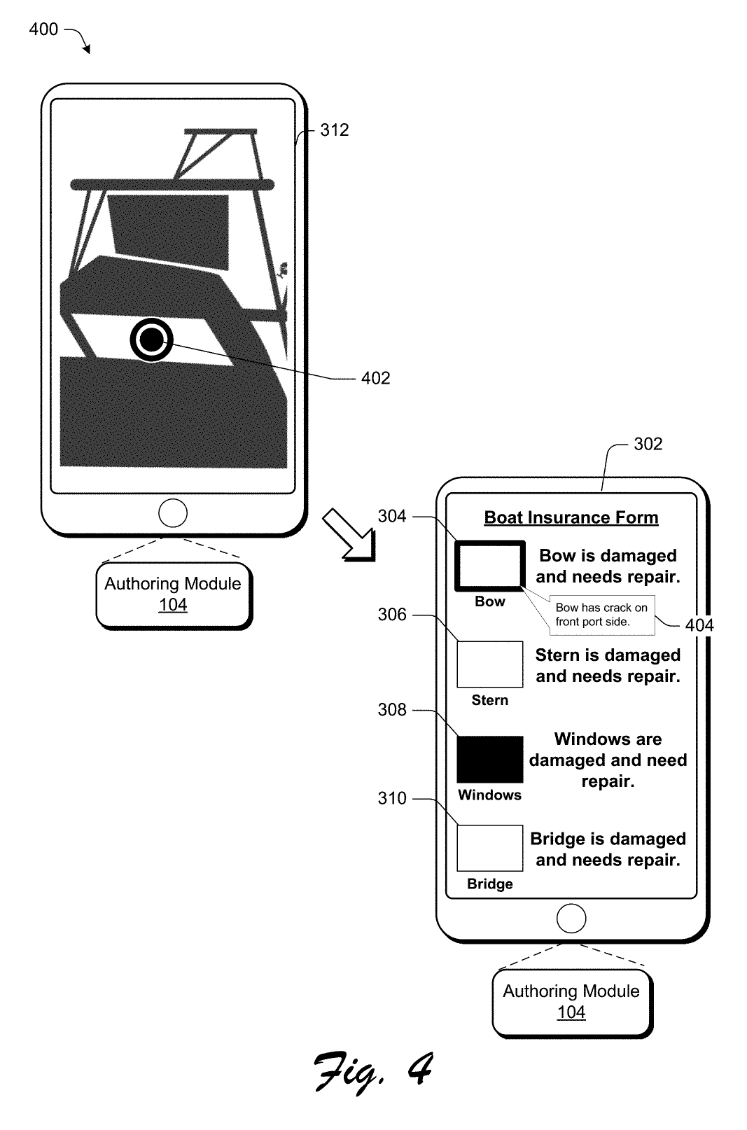

FIG. 4 depicts an example implementation, generally at 400, showing functions of the authoring module 104 starting from the digital representation instead of the document as in FIG. 3. In this example, the bow portions of the document and the digital representation are already linked, however, there does not need to be an existing link to start from the digital representation. Regardless of whether an existing link exists, an input is received by the authoring module 104 navigating the digital representation of the boat 312 to another portion of interest, in this case, a windows portion of the digital representation of the boat 402. The navigation may be any 2D or 3D manipulation of the digital representation of the object, or in the case of a VR environment, a manipulation of the object in 2D or 3D. In this case, the digital representation of the boat is manipulated to a windows portion of the digital representation of the boat 402. A user input is then received by the authoring module 104 selecting the windows portion of the digital representation of the boat 402 for linking. The selection may either save a view at the time the portion is selected, save coordinates of the portion, or save any other navigational resources needed to navigate to the portion and/or identify the portion from the rest of the digital representation. Responsive to receiving the portion selection, the authoring module 104 causes the user interface to navigate to the boat insurance form 302.

In this example, bow portions of the document and the digital representation are already linked (as shown by the thicker border around the bow section of the boat insurance form 304), however, an existing link does not need to exist to link a portion from the digital representation to a portion of the document. A text comment 404 describing the linked bow portions has also been included as part of the previous linking of the bow sections. In this example, text comment 404 adds details about the damage associated with the bow such that a user receiving the linked document may be able to quickly find the pertinent information associated with the link. Although shown as text, the added information may contain audio/video associated with the link or any other information describing the link and/or the respective portions. The text comment 404 is also linked to the digital representation of the boat 312, however, it is hidden from view as the linked bow portion of the digital representation of the boat 314 is occluded from view.

If a portion has not previously been linked, the authoring module 104 may receive a user input selecting or creating a document to link to the digital representation. Either way, a user input is received by the authoring module 104 defining the windows portion of the boat insurance form 308 to be linked to the windows portion of the digital representation of the boat 402. Responsive to receiving the user input defining the windows portion of the boat insurance form 308, the authoring module 104 links the windows portion of the digital representation of the boat 402 to the windows portion of the boat insurance form 308.

Although another portion of the document is shown as being linked, an existing linked portion may be chosen to change an association. For example, if the user input was received to the bow section of the boat insurance form 304 during the portion linking process of FIG. 4, the pre-existing linked portion (assuming bow section of the boat insurance form 304 is already linked) may be updated to associate the bow section of the boat insurance form 304 with the windows portion of the digital representation of the boat 402.

Once portions are linked between the document and the digital representation, an input received to a linked portion in the document will cause a navigation to the respective linked portion in the digital representation, and, conversely, an input received to a linked portion in the digital representation will cause a navigation to a respective linked portion in the document. Through use of the techniques described herein, a user can link a portion of a digital representation of an object to a portion of a document. This enables a user to easily navigate between linked portions of the document and the digital representation of the object which is user friendly, removes the need for multiple digital representations to be attached, and removes ambiguity when referencing portions.

Example Procedures

The following discussion describes contextual linking of digital representations of objects with documents that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

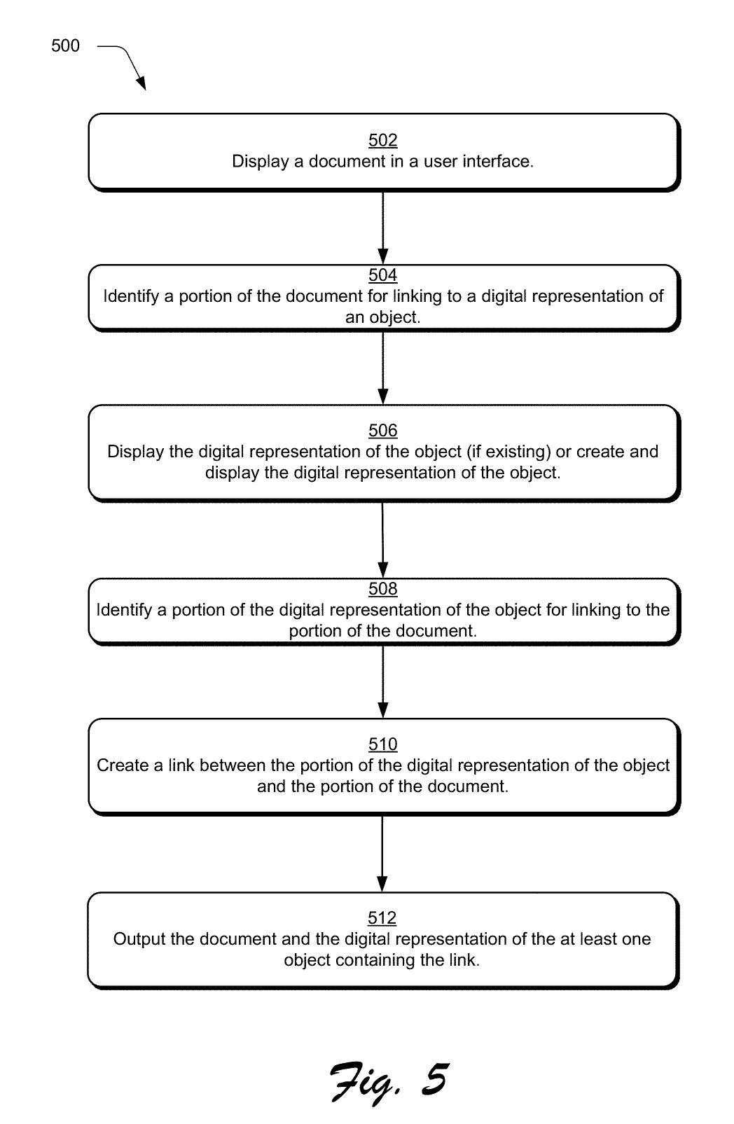

FIG. 5 depicts, generally at 500, a procedure in an example implementation in which a computing device links a portion of a document to a portion of a digital representation of an object.

First, the computing device displays a document in a user interface (step 502). The document may be any electronic file for which a user may wish to link portions to a digital representation of an object. For example, the document may be a PDF of an insurance form that contains form fields that a user may wish to link to various views of a VR vehicle.

Second, the computing device identifies a portion of the document for linking to a digital representation responsive to receiving a user input to the portion of the document (step 504). Examples of this type of user input are a gesture to a touchscreen (circling a particular portion), defining a window, placing a locator pin, a mouse function, and so on. An example document portion may be a portion of the boat insurance form (e.g., a form field) associated with the bow of a boat.

Third, the computing device displays an existing digital representation of the object or creates a digital representation of the object if it does not exist prior (506). For example, the computing device may utilize a camera or other imaging device to create a digital representation of a boat for linking to the boat insurance form.

Fourth, the computing device identifies a portion of the digital representation for linking to the portion of the document selected in step 504 responsive to receiving a user input to the portion of the digital representation (step 508). This type of user input is similar to the user input defining the document portion, i.e. a gesture to a touchscreen (circling a particular portion), defining a window, placing a locator pin, a mouse function, and so on. The portion of the digital representation may also be automatically determined by the computing device absent a user input and be confirmed or adjusted by the user input for linking to the document portion.

Fifth, the computing device creates a link between the portion of the digital representation of the object and the portion of the document (step 510). The link may contain hyperlinks or other navigation instructions that enable specific navigations to the document portion or the digital representation portion when the link is activated at either the document portion or the digital representation portion.

Sixth, the computing device outputs the document and the digital representation of the object containing the link (step 512). The digital representation may be embedded within the document, attached to the document, contained at a URL address associated with the document, and so on.

Although the above procedure starts with a document, the process may start with the digital representation. In this way, the computing device may identify a portion of the digital representation first and then subsequently identify a portion of a document to link to the portion of the digital representation.

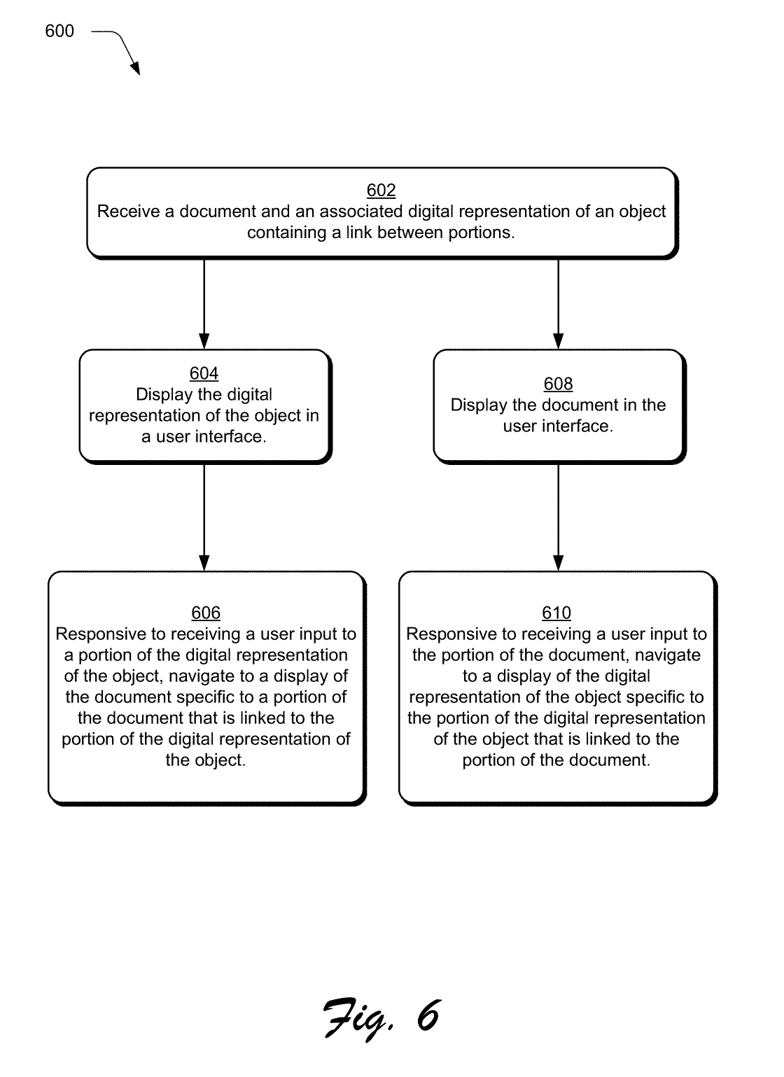

FIG. 6 depicts, generally at 600, a procedure in an example implementation in which a computing device navigates between a document and a digital representation of an object responsive to receiving a user input to a linked portion.

First, the computing device receives a document and an associated digital representation of an object containing a link between portions (step 602). The digital representation may be embedded within the document, attached to the document, contained at a URL address associated with the document, and so on.

As a first option, the computing device displays the digital representation of the object (step 604). An example of a digital representation is a boat within a virtual reality environment such that a user can manipulate the boat in three dimensions.

Next, the computing device receives a user input to a portion of the digital representation (step 606). The digital representation of the object may be manipulated in any number of ways (zoom, translation, rotation, etc.), however, as long as the digital representation portion is visible, it may be selected. For example, there may be a number of views of the VR boat discussed above that contain the bow portion, all of which may enable a user to select the bow portion. Regardless of the view in which the input is received, responsive to receiving the input, the computing device displays the document and navigates to a specific view of the document corresponding to the portion of the document that is linked to the portion of the digital representation (step 606). For example, an input corresponding to a bow of the digital representation of the boat causes the computing device to navigate to a view surrounding a portion of a boat insurance form associated with the boat bow.

The navigation is defined by the link between the linked portions. The link may contain coordinates of the document portion or other information that enables the computing device to identify and navigate to the document and more specifically to the view of the document portion. The view specific to the document portion may comprise a highlighting of the document portion, a view centered around the document portion, a view differentiating the document portion from other portions of the document, and so on. In one implementation, the computing device may display a preview of the navigation showing the document portion prior to the navigation. For example, the computing device may display a preview of the specific view of the document portion concurrently within the display of the digital representation when a hover over input is received at the digital representation portion.

Alternatively, the computing device displays the document (step 608), and receives a user input corresponding to a portion of the document. The document may be manipulated in any number of ways (zoom, translation, rotation, etc.), however, as long as the document portion is visible, it may be selected. For example, there may be a number of views of the boat insurance form discussed above, all of which may enable a user to select the bow portion as long as it is visible in a particular view. Regardless of the view in which the input is received, responsive to receiving the input, the computing device navigates to a specific view of the digital representation corresponding to the portion of the digital representation that is linked to the portion of the document (step 610). Continuing the above example, the computing device may navigate to a portion of the digital representation of the boat bow responsive to receiving an input corresponding to the boat bow portion of the boat insurance form. This navigation is also defined by the link between the portions.

The link may contain coordinates of the digital representation portion or other information that enables the computing device to identify and navigate to the digital representation, and, more specifically, to the view of the digital representation portion. The view specific to the digital representation portion may comprise a highlighting of the digital representation portion, a view centered around the digital representation portion, a view differentiating the digital representation portion from other portions of the digital representation, and so on. Similar to step 606, the computing device may display a preview of the navigation showing the digital representation portion prior to the navigation. For example, the preview of the digital representation portion may be displayed within the display of the document at all times, i.e. a thumbnail if a space is designated for pictures.

Example System and Device

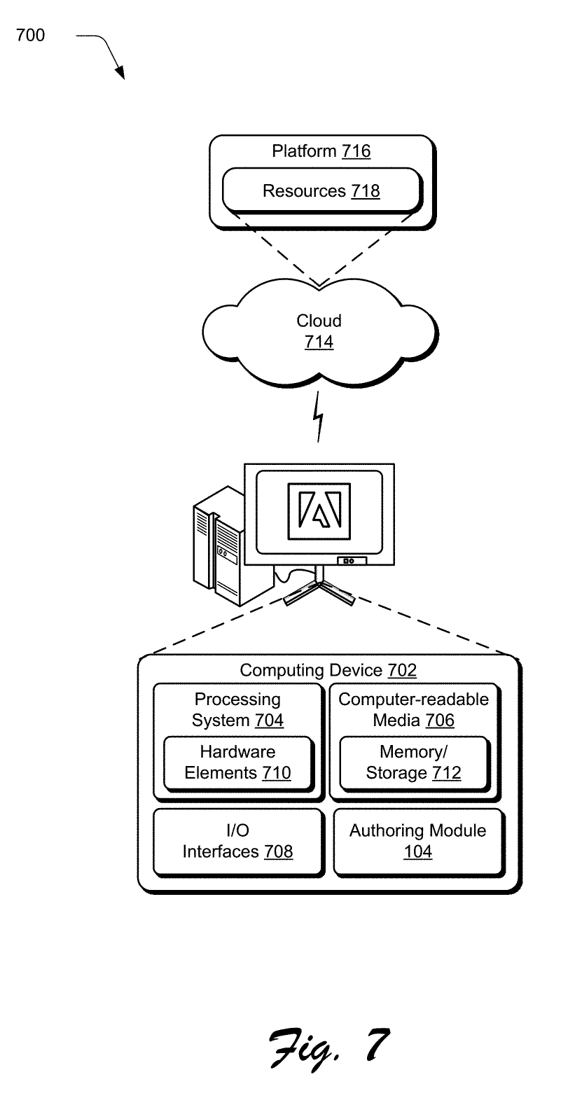

FIG. 7 depicts, generally at 700, an example implementation showing an example computing device 702 that is representative of one or more computing systems and/or devices that may implement the various techniques described herein. This is illustrated through inclusion of the authoring module 104, which may be configured to link a portion of a document to a portion of a digital representation of an object. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be configured as of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device implementation, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. In a digital medium environment in which a portion of a digital representation of an object is linked to a portion of a document, a method comprising:
receiving, by at least one computing device, an input identifying a first portion of a plurality of portions of the document;
receiving, by the at least one computing device, an input identifying a first view of a plurality of views of the portion of the digital representation of the object, the digital representation of the object included in the document, the plurality of views corresponding to different locations with respect to the digital representation of the object;
generating, by the at least one computing device, a link that is user selectable to navigate back and forth between the first portion of the document and the first view of the portion of the digital representation of the object; and
outputting, by the at least one computing device, the document having the generated link.

2. A method as described in claim 1, wherein the receiving of the input identifying the first portion of the document is performed automatically and without user intervention using text recognition.

3. A method as described in claim 1, wherein the receiving of the input identifying the first view of the portion of the digital representation of the object is performed automatically and without user intervention using object recognition.

4. A method as described in claim 1, wherein the document comprises a portable document format (PDF) and the first portion of the document is a form field.

5. A method as described in claim 1, wherein the digital representation of the object comprises a virtual reality environment containing the object.

6. A method as described in claim 1, wherein the digital representation of the object is a two-dimensional or three-dimensional image.

7. A method as described in claim 1, wherein the digital representation of the object is created, by the at least one computing device, by stitching together two or more two-dimensional images.

8. A method as described in claim 1, wherein the digital representation of the object is created, by the at least one computing device, responsive to receiving the indication of the first portion of the document.

9. A method as described in claim 1, wherein the digital representation of the object is retrieved from a database of digital representations of the object and other respective objects.

10. A method as described in claim 1, wherein the first view of the portion of the digital representation of the object is indicated responsive to receiving, by the computing device, a gesture proximal to the portion of the digital representation of the object.

11. A method as described in claim 1, wherein the document contains a visual indication that the first portion of the document is linked to the first view of the portion of the digital representation of the object responsive to generating the link.

12. A method as described in claim 1, wherein the outputting comprises outputting the document with the digital representation of the object attached to the document.

13. A method as described in claim 1, wherein the link causes a display of a preview of the identified view of the portion of the digital representation of the at least one object responsive to another user input to the portion of the document and a display of a preview of the portion of the document responsive to another user input to the portion of the digital representation of the at least one object.

14. At least one computer-readable storage media device comprising instructions stored thereon that, responsive to execution by a processing system, causes the processing system to implement operations comprising:
receiving a document and a user-manipulable 3D object, in which, portions of the document are linked to portions of the 3D object;
navigating from a first view of the document to a first view of a first portion of the 3D object responsive to receiving a user input at a first linked portion of the document;
manipulating the 3D object to display a second view of a second portion of the 3D object responsive to a navigational user input;
navigating from the second view of the second portion of the 3D object to a second view of a second portion of the document responsive to receiving a user input at the second portion of the 3D object.

15. At least one computer-readable storage media device as described in claim 14, further comprising:
displaying a preview of the first view of the first portion of the 3D object concurrent with the first view of the document in the user interface prior to performing the navigating to the first view of the first portion of the 3D object; and
displaying a preview of the second view of the second portion of the document concurrent with the second view of the 3D object in the user interface prior to performing the navigating to the second view of the second portion of the document.

16. At least one computer-readable storage media device as described in claim 14, wherein the first view of the document is different than the first view of the first portion of the document and the first view of the 3D object is different than the first view of the first portion of the 3D object.

17. In a digital medium environment in which a portion of a manipulable 3D object is linked to a portion of a document, a method comprising:
a step for identifying a first portion of the document from a plurality of portions of the document;
a step for identifying a first portion of the 3D object from a plurality of portions of the 3D object, the 3D object included in the document, the plurality of portions corresponding to different locations with respect to the 3D object;
a step for generating a link between the first portion of the document and the first portion of the 3D object that is user selectable to navigate back and forth between a first display of the first portion of the 3D object and a first display of the first portion of the document; and
a step for outputting the document and the 3D object containing the link.

18. (canceled)

19. A method as described in claim 17, wherein the link contains one or more of notes, text, audio, video, annotations, or other information received via a user input describing the link.

20. A method as described in claim 17, further comprising a step for creating the 3D object.

21. A method as described in claim 17, further comprising:
a step for receiving a user input indicating a modification to the 3D object; and
a step for modifying the document and the link based on the modification to the 3D object.
